(19) United States
(12) Patent Application Publication
(10) Pub. No.: US 2026/0139082 A1
(43) Pub. Date: May 21, 2026

(54) LOW TEMPERATURE SYNTHESIS OF CARBONACEOUS ELECTRODES THROUGH LASER-REDUCTION FOR ELECTROCHEMICAL APPLICATIONS

(71) Applicants: Fikile BRUSHETT, Cambridge, MA (US); Jeffrey C. GROSSMAN, Cambridg, MA (US); Massachusetts Institute of Technology, Cambridge, MA (US)

(72) Inventors: Fikile Brushett, Cambridge, MA (US); Jeffrey C. Grossman; Charles Tai-chieh Wan, Cambridge, MA (US); Jatin Jaytesh Patil; Sheng Gong

(21) Appl. No.: 19/121,047

(22) PCT Filed: Oct. 11, 2023
(86) PCT No.: PCT/US23/76558

§ 371 Date: Apr. 14, 2025

Related U.S. Application Data
(60) Provisional application No. 63/379,278, filed on Oct. 12, 2022.

(51) Int. Cl. C08F 120/44; H01M 4/86; H01M 4/88; H01M 4/96; H01M 8/18

(52) U.S. Cl. CPC C08F 120/44; H01M 4/8605; H01M 4/8875; H01M 4/96; H01M 8/188

(57) ABSTRACT

Disclosed are methods for making lased poly(acrylonitrile) (PAN). Also disclosed herein are components (e.g., electrodes and batteries) comprising lased PAN.

### RELATED APPLICATIONS

This application claims the benefit of priority to U.S. Provisional Patent Application No. 63/379,278, filed Oct. 12, 2022, the contents of which are hereby incorporated by reference in their entirety.

### GOVERNMENT SUPPORT

This invention was made with government support under DE-AC02-06CH11357 awarded by the U.S. Department of Energy. The government has certain rights in the invention.

### BACKGROUND

Graphitic and carbonaceous materials are commonly utilized as core components in electrochemical devices, water treatment, and sensing. However, these application areas have usually required either extensively processed graphite or mixtures of carbon, or energy-intensive processing, such as chemical vapor deposition. Moreover, there is a vast body of literature on the optimization of materials properties tailored with specific functionalities. However, given the vast number of parameters and approaches involved with optimizing carbonaceous materials, it is evident that such optimization frameworks are challenging to establish and test.

Conventional means of synthesizing carbonaceous materials through thermal processing in furnaces require accessing temperature above 2000° C., which can be cumbersome, time-consuming, and costly. The extreme temperature thresholds to be met for carbonization approaches the melting points of many common metals, necessitating specialized, custom-built graphite ovens. These hardware limitations motivate versatile, low-temperature, and high-throughput manufacturing routes. To this end, laser-annealing has emerged as a promising means to rapidly generate high-quality carbonaceous and graphitic material from polymer precursors with lower energy requirements and higher throughput than standard thermal processing. Laser-annealing leverages the strong optical absorption of polymers in specific wavelength ranges (for example, at 10.6 μm), which causes them to experience temperatures of over 2500° C. under very short timescales without external heating. Despite the benefits of laser-annealing, a limited set of polymers have been demonstrated to be “laseable,” or able to be converted successfully to carbonaceous material when subjected to lasing. Previous works have aimed to identify criteria for the “laseability” of materials, although many commonly employed polymer precursors are still considered to be unfit for lasing. Of particular interest among these polymers is polyacrylonitrile (PAN), which can be used to manufacture the porous carbon electrodes that underpin electrochemical devices. PAN has repeatedly been identified as a polymer that cannot be laser-annealed effectively. However, recent work has shown that even reportedly laseable polymers may need pre-treatments to surmount phase transitions that might cause melting or ablation. In the case of PAN, the polymer typically undergoes a multi-step heat-treatment, whereby the material is thermally treated in air at lower temperatures (usually a maximum of 300° C.) and then pyrolyzed at higher temperatures to increase graphitization content. The thermal stabilization is essential for crosslinking the PAN and improving the ensuing mechanical properties of the electrode after carbonization. The overall process is also crucial to preserve the structure and hence electrochemical performance of the carbon electrode.

### SUMMARY OF THE INVENTION

Laser-reduction of polymers has recently been explored to rapidly and inexpensively synthesize high-quality graphitic and carbonaceous materials from commercial polymers. Such easily synthesizable carbonaceous structures hold promise in being utilized for a broad range of electrochemical applications, including in energy storage. However, in past work, laser-induced graphene has been restricted to semi-aromatic polymers and graphene oxide—in particular, poly(acrylonitrile) (PAN) is claimed to be a polymer that cannot be laser-reduced successfully to form electrochemically-active material. In this work, three strategies to surmount this barrier are employed: (1) thermal stabilization of PAN (resulting in thermally stabilized PAN (TS-PAN)) to increase its sp² content for improved laser processability, (2) pre-laser treatment microstructuring to reduce the effects of thermal stresses, and (3) Bayesian Optimization to search the parameter space of laser processing to improve performance and discover new morphologies. Based on these approaches, we demonstrate the lowest reported sheet resistance (6.5 Ω/sq) derived from laser-reduction of any synthetic polymer with a single lasing step, in addition to demonstrating successful laser reduction of PAN for the first time. The resulting materials are tested electrochemically for activity, and their application as membrane electrodes for vanadium redox-flow batteries is demonstrated. Electrode performances are lower than conventional electrodes, but our approach realizes membrane electrodes that are processed in air, below 300° C. which are cycled stably over 2 weeks at 40 mA cm⁻², motivating further development of laser-reduction of porous polymers for membrane electrode applications such as RFBs.

In one aspect, the present disclosure provides methods for making lased poly(acrylonitrile) (PAN), comprising
microstructuring the membrane;
thermally treating the membrane in air to produce a membrane comprising thermally stabilized PAN, wherein the thermal treating occurs at less than 300° C.; and
laser annealing the thermally stabilized membrane to produce lased PAN with a decreased sheet resistance, as compared to microstructured PAN, wherein the laser annealing is conducted by a computer comprising a Bayesian optimization program.

In another aspect, the present disclosure provides lased PAN membrane comprising the lased PAN produced by the methods disclosed herein.

In another aspect, the present disclosure provides electrode comprising the lased PAN membrane disclosed herein.

In another aspect, the present disclosure provides a battery comprising the lased PAN membrane disclosed herein.

In another aspect, the present disclosure provides a computer system for laser annealing a membrane comprising poly(acrylonitrile) (PAN), comprising:
a. a processing system;
b. computer storage accessible to the processing system, and
c. computer program instructions encoded on the computer storage, wherein when the computer program instructions are processed by the processing system, the computer system is configured to:
   i. define data structures in the computer storage representing the PAN membrane; and
   ii. execute instructions to the laser to irradiate the PAN membrane to optimize reduction of electrical resistance of the PAN membrane.

### BRIEF DESCRIPTION OF THE DRAWINGS

FIG. 1A shows the chemical structure of PAN and possible structures in TS-PAN, showing increased conjugation in thermally stabilized polymer.

FIG. 1B shows an illustration of the Bayesian Optimization process, showing the exploration and exploitation process in the Bayesian optimization algorithm, around the ground truth of ideal parameters.

FIG. 1C shows the experimental cycle for initial optimization. Samples are fabricated with input parameters, then tested for linear resistance across a 1 cm square, followed by feeding results into the Bayesian optimization algorithm; this process is repeated for 8 cycles.

FIG. 1D shows that for electrochemical tests, the optimized parameters are used to lase both sides of the TS-PAN.

FIG. 1E shows a general schematic of the cyclic voltammetry results that informed optimal lasing conditions to test for the RFB experiment.

FIG. 2A shows an illustration of the full Bayesian Optimization process to find the lowest resistance, where illustrated points show the best resistance measured over a set of 20 samples.

FIG. 2B shows an illustration of the full 3D space of exploration, where all image densities are explored in each point.

FIG. 2C shows a full illustration of explored power vs. Z, showing the exploration of a wide space of parameters to find the overall minima across the imposed boundary conditions.

FIG. 2D shows a representative Raman spectrum of select points in the optimization process, showing a progression towards an intermediate between highly graphitic/carbonized electrode.

FIG. 2E shows the effect of parameter values on the overall R outcome, where positive SHAP value represents a parameter expecting to reduce R, while a negative SHAP value represents an expected increase in R.

FIGS. 3A-3D show the exploration of the physiochemical morphology of optimized electrodes.

FIG. 3A shows a current-voltage plot of lased electrodes in 50 mM Fe^{2+/3+} in 1 M KCl, showing the higher electrochemical activity corresponding to the lower-image-density electrodes.

FIG. 3B shows Raman spectra of both electrodes, showing that lower image densities preserve graphitic features which improve electrochemical activity, but reduce sheet resistance.

FIG. 3C shows C1s XPS scans showing the changes in degree of reduction in the electrodes after lasing for low ID.

FIG. 3D shows C1s XPS scans showing the changes in degree of reduction in the electrodes after lasing for high ID.

FIGS. 4A-4E show scanning electron images of cross sections of parameter 1 (FIG. 4A), parameter 2 (FIG. 4B), and parameter 3 (FIG. 4C), with high-magnification insets. Scale bars are 100 μm, and 10 μm for insets. Parameter values used for each are listed in the SI. X-ray photoelectron spectra for C1s peaks, with deconvoluted peaks are shown for parameter 1 (FIG. 4D), parameter 2 (FIG. 4E), and parameter 3 (FIG. 4F). Each spectrum is deconvoluted to resolve contributions from specific carbon chemistries. FIG. 4G shows Raman spectra from the top and bottom of each electrode, showing the range of electrode surface morphologies achievable despite similar R values in the BO optimization step.

FIG. 5A shows representative cyclic voltammograms of lased electrodes compared to furnace annealed samples at 1050° C. at scan rates of 1, 3, 5, and 10 mV s⁻¹. Electrolyte compositions were 50 mM V(IV) and 50 mM V(V) in 3 M H₂SO₄.

FIG. 5B shows peak currents as a function of the scan rate.

FIG. 5C shows Peak-to-peak separation as a function of the scan rate. The working, counter, and reference electrodes used were a 0.5×0.5 cm² geometric area porous electrode, a Pt coil, and Ag/AgCl in 3 M NaCl.

FIGS. 6A-6G show that galvanostatically cycled electrodes in a VRFB operated at different current densities. Param 2 cell capacity (FIG. 6A) and efficiency under cycling (FIG. 6B). Param 3 cell capacity (FIG. 6C) and efficiency (FIG. 6D) under cycling. Long term stability tests for Param 2 showing efficiency vs. cycle number (FIG. 6E), and discharge capacity vs. cycle number (FIG. 6F), which represents 2 weeks of cell cycling. Comparison of electrochemical impedance spectroscopy of Param 2 and Param 3 electrodes at a flow rate of 25 mL min⁻¹ (FIG. 6G).

FIG. 7A shows laser reduction attempts on PAN without thermal stabilization. The power threshold between no change versus complete ablation is very sharp, indicating that lasing PAN as is proves to be challenging.

FIG. 7B shows the laser reduction of 100 μm-thick PAN disks. Every parameter results in cracking or complete disintegration of the material.

FIG. 7C shows the only stable configurations (such as the middle disk), through optical microscope, undergo rapid delamination of partially reduced material, where the bands aligning with laser raster lines on the top left are slightly carbonized, while the underlying layer is melted.

FIG. 7D shows Raman spectroscopy of delaminated sheets showing signature D, G, and 2D peaks.

FIG. 8A shows the normalized measured 1/R versus predicted 1/R from GP in EDBO at #7.

FIG. 8B shows the evolution of R2 scores of predictions of 1/R from GP in EDBO and NN in this work.

FIG. 8C shows R2 scores of surrogate models in EDBO for fitting 1/R at #7.

FIG. 9 is a block diagram of a general-purpose computer which processes computer programs using a processing system.

### DETAILED DESCRIPTION OF THE INVENTION

In this work, we demonstrate that for PAN, two strategies are needed to yield graphitized structures: (1) a thermal stabilization step to prevent melting or ablation from the rapid material changes induced by laser processing, and (2) microstructuring of the polymer, since planar, monolithic PAN undergoing laser reduction also undergoes thermal stresses which cause ablation and delamination of graphitic material. Subsequently, we show that with these strategies, lased PAN forms freestanding structures that are electrochemically active and can be leveraged as porous electrodes for vanadium redox flow batteries (VRFBs), an electrochemical technology holding promise for reliable and robust energy storage. While we envision that lased PAN can be tailored for a variety of uses, we specifically targeted the development of the carbonaceous electrodes used within the RFB reactor because they perform numerous critical roles, such as providing pathways for electrons and heat, hosting actives sites for electrochemical reactions, and impacting the pressure drop across the reactor manifold as fluid is forcibly advected through the electrode pores: these requirements necessitate a lasing process yielding electrodes with freestanding and robust form factors and electrochemically active interfaces.

However, since the laser-reduction of PAN represents a completely uncharted material system, in addition to the introduction of the porous motif, we use Bayesian Optimization (BO) to explore the large phase-space of experimental conditions. BO is an uncertainty-guided optimization method for complex black-box objective function. It consists of two basic steps: exploitation and exploration. In exploitation, BO suggests that candidate points with the optimal predicted properties should be tested. Conversely, during exploration, BO suggests that high-uncertainty candidate points should be tested. The balance between exploitation and exploration is controlled by the choice of the acquisition function. Turner et al. have shown that BO is superior to random search for black-box optimization problems such as machine learning hyperparameter tuning, and Shields et al. has even demonstrated that BO outperforms human decision-making for optimization of some chemical reactions. Consequently, BO has been increasingly used to tune experimental parameters in the field of chemistry and materials science. Given the massive amount of possible laser conditions, BO seems to be useful to find appropriate lasing conditions within a reasonable number of trials, and Wahab et al. have employed BO to guide the laser-processing of graphene.

However, lasing PAN might be an even more challenging problem for BO than in most prior reports. In previous studies, BO seldom yields a counter-intuitive result. Here, the task of lasing PAN to make it conductive is itself counter-intuitive, as previous works note the unlaseability of PAN. In this sense, BO is employed to discover new paradigms rather than to optimize a well-known physical and chemical process. More specifically, in our process, human intervention is expected to be necessary while operating BO. Recently, BO has been increasingly combined in the autonomous platform of experiments where BO is conducted in a human-defined search space without human-intervention during the optimization. The search of lasering conditions for graphene is also conducted in this autonomous way. Pre-defining the search space is important for such autonomous optimization, because there is a trade-off between efficiency and effectiveness: if the search space is too large, then the steps to reach the optimum might be larger; otherwise, the optimum might not be included. Unlike polymers such as polyimide and poly(ethersulfone) which are known to be laseable, there is limited information about lasing PAN. Therefore, it is possible that the pre-defined search space might be too large or too small, and manual adjustment of the search space might be necessary during the operation of BO—where the initial search parameters in this study are chosen based on an optimum derived from numerous experiments on a completely different material system (graphene oxide). Moreover, different PAN lasing conditions are shown to result in different carbon properties (as a spectrum between graphitic and carbonized), and consequently, the impact of different lasing conditions on the morphology and property of PAN might be highly nonlinear and non-smooth, which is challenging for the standard BO based on Gaussian Process (GP). Third, in most cases. BO focuses on a single aspect of the materials system, while in our case, during the optimization, other aspects of materials might also change and impact the merits of the materials. Fourth, unlike lasing conventional monolithic polymers, where resulting structures are physically more predictable and can thus be investigated easily through Raman spectroscopy, we use the linear resistance (R) to rapidly probe the overall progression of the lasing process to approach a conductivity regime where electrochemical properties can be further investigated.

In one aspect, the present disclosure provides method for making lased poly(acrylonitrile) (PAN), comprising:
microstructuring the membrane:
thermally treating the membrane in air to produce a membrane comprising thermally stabilized PAN, wherein the thermal treating occurs at less than 300° C.; and
laser annealing the thermally stabilized membrane to produce lased PAN with a decreased sheet resistance, as compared to microstructured PAN, wherein the laser annealing is conducted by a computer comprising a Bayesian optimization program.

In certain embodiments, the thermal treating occurs at about 200° C. to about 299° C. In certain embodiments, the thermal treating occurs at about 200° C. about 220° C., about 240° C. 260° C., or about 280° C. In certain embodiments, the thermal treatment increases the sp² content of the PAN as compared to PAN that has not been thermally treated. In certain embodiments, the thermally stabilized PAN comprises a high degree of carbonized and graphitized PAN. In certain embodiments, the thermally stabilized PAN comprises a high degree of carbonized and graphitized PAN, as compared to PAN that has not been thermally treated.

In certain embodiments, the Bayesian Optimization program minimizes PAN electrical resistance by exploring one or more laser parameters selected from the group consisting of laser scan speed, laser power, focal point height (Z), and image density (ID).

In certain embodiments, the Bayesian Optimization program minimizes PAN electrical resistance by conditioning the microstructured PAN using a laser having a Z-height, an image density, a power, and a speed.

In certain embodiments, the Z-height is from 0.02 inches to 0.2 inches. In certain embodiments, the Z-height is from 0.02 inches to 0.14 inches. In certain embodiments, the Z-height is about 0.02 inches. In certain embodiments, the Z-height is about 0.14 inches.

In certain embodiments, the image density is 1 to 10. In certain embodiments, the image density is 3, 4, 5, 6, or 7. In certain embodiments, the image density is 5 or 7. In certain embodiments, the image density is 5. In certain embodiments, the image density is 7.

In certain embodiments, the power is 2 to 10 watts. In certain embodiments, the power is about 3, about 3.5, about 4, about 4.5, about 5, about 5.5, about 6, about 6.5, about 7, about 7.5, about 8, about 8.5, or about 9 watts. In certain embodiments, the power is about 4.5 or about 9 watts.

In certain embodiments, the speed is 120 to 200 mm/s. In certain embodiments, the speed is about 110, about 115, about 120, about 125, about 130, about 135, about 140, about 145, or about 150 mm/s. In certain embodiments, the speed is about 130 mms.

In certain embodiments, the lased PAN is electrochemically active.

In certain embodiments, the lased PAN has a resistance of about 5-20 Ω/sq. In certain embodiments, the lased PAN has a resistance of about 5-10 Ω/sq. In certain embodiments, the lased PAN has a resistance of about 2 Ω/sq, 3 Ω/sq, 4 Ω/sq, 5 Ω/sq, 7 Ω/sq, 8 Ω/sq, 9 Ω/sq, or about 10 Ω/sq. In certain embodiments, the lased PAN has a resistance of about 6.5 Ω/sq.

In certain embodiments, the lased PAN has an increased number of graphitic dendritic structures, as compared to un-lased PAN. In certain embodiments, the lased PAN has an increased number of edge sites, as compared to un-lased PAN. In certain embodiments, the lased PAN are configured to function as porous electrodes for a vanadium redox flow battery.

In another aspect, the present disclosure provides lased PAN membrane comprising the lased PAN produced by the methods disclosed herein.

In another aspect, the present disclosure provides electrode comprising the lased PAN membrane disclosed herein.

In another aspect, the present disclosure provides a battery comprising the lased PAN membrane disclosed herein.

In another aspect, the present disclosure provides a computer system for laser annealing a membrane comprising poly(acrylonitrile) (PAN), comprising:
a. a processing system;
b. computer storage accessible to the processing system, and
c. computer program instructions encoded on the computer storage, wherein when the computer program instructions are processed by the processing system, the computer system is configured to:
   i. define data structures in the computer storage representing the PAN membrane; and
   ii. execute instructions to the laser to irradiate the PAN membrane to optimize reduction of electrical resistance of the PAN membrane.

In another aspect, the present disclosure provides a computer program product comprising computer storage and computer program instructions encoded on the computer storage, wherein the computer program instructions, when processed by a processing system of a computer, causes the computer to perform the laser annealing disclosed herein or implement the computer system disclosed herein.

### Definitions

Unless otherwise defined herein, scientific and technical terms used in this application shall have the meanings that are commonly understood by those of ordinary skill in the art. Generally, nomenclature used in connection with, and techniques of chemistry described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C. A. (1985).

As used herein, the term “image density” refers to the number of lines per inch at which the light source (e.g., a laser) rasters. For example, an image density refers of one to 15 lines per inch (LPI) and each integer thereafter corresponds to 15 additional LPI (e.g., an image density of 2 is 30 LPI, an image density of 3 is 45 LPI etc.). All of the above, and any other publications, patents and published patent applications referred to in this application are specifically incorporated by reference herein. In case of conflict, the present specification, including its specific definitions, will control.

### EXAMPLES

The invention now being generally described, it will be more readily understood by reference to the following examples, which are included merely for purposes of illustration of certain aspects and embodiments of the present invention, and they are not intended to limit the invention.

### Example 1: Preparation and Characterization of Exemplary Electrodes

### A Priori Knowledge and Insights Needed to Start Bayesian Optimization

To approach the problem of laser-processing PAN, we begin by verifying the prevailing knowledge in the current body of literature. After testing lasing parameters on as-prepared PAN membranes (as described below), we verify that the polymer is either unaffected when below a certain power threshold, or completely melts or burns above the threshold, which does not result in a conductive structure as previously described. Therefore, we identify a need to further process PAN from its native state.

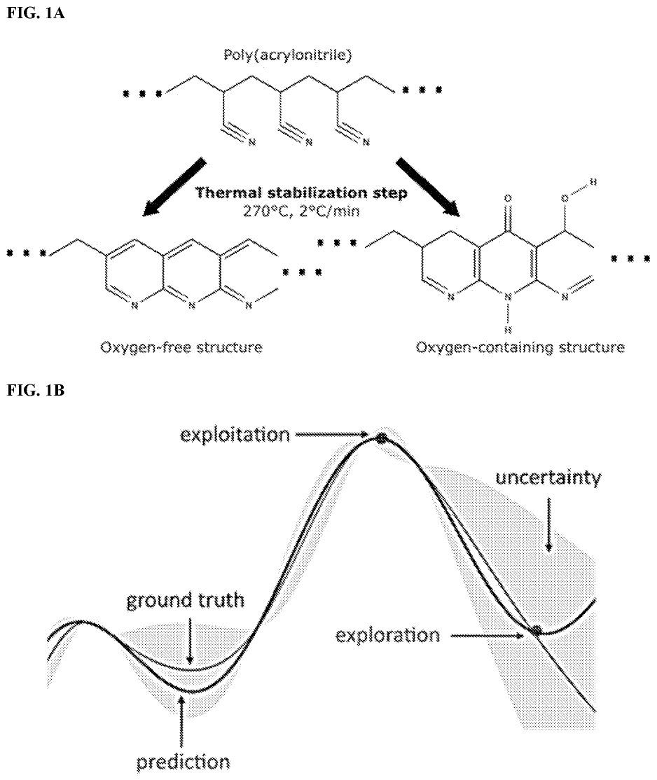

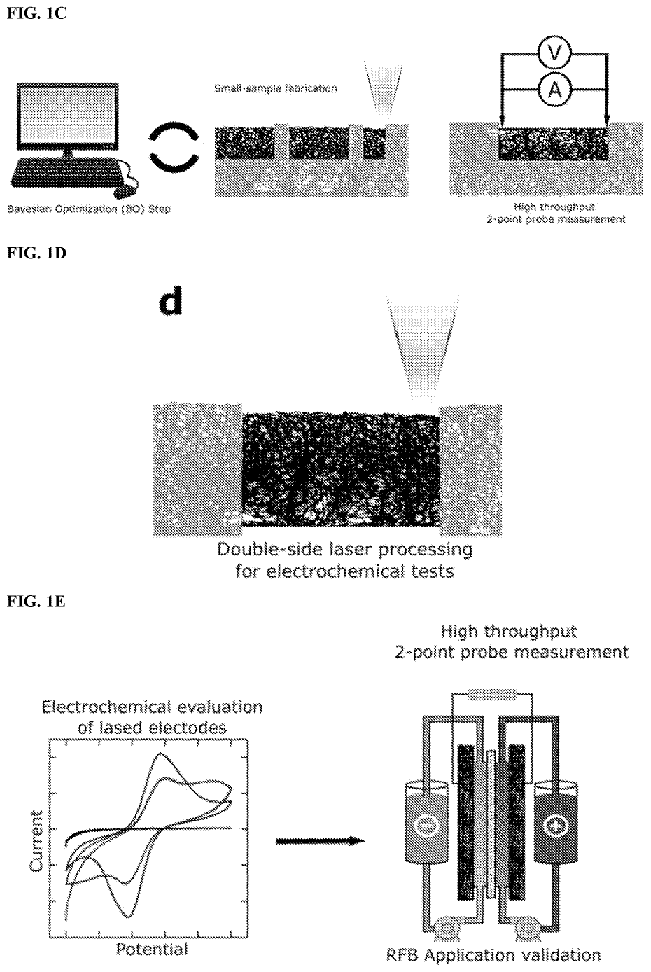

PAN is often thermally stabilized to transition it into a morphology that can be effectively carbonized and graphitized, and this property has been well-explored especially through carbon-fiber synthesis (FIG. 1A). However, a purely sp²-character precursor is not ideal for the process to occur—in fact, a balance of sp² and sp³ nature in a material has been shown to promote graphitization. Therefore, the stabilization process in air is shown to promote this morphology.

This process causes rapid thermal expansion and contraction associated with the fast timescales of the lasing process, and the high temperatures experienced due to the absorption process and subsequent chemical changes (such as graphitization) of the polymer can lead to ablation and mechanical stresses that prevent bulk structures from being realized through the lasing process. We thus identify micro-structuring to mitigate ablation or cracking of the polymer, and this is shown to yield high-quality graphitized material with minimal ablation.

As an initial input into the system, we explore a sample space of previously probed parameters (such as laser scan speed, laser power, focal point height (Z), and image density (ID)), which are each described in the Methods section. Based on intuition from graphene-oxide, we choose constraints on each of the variables to limit the initial exploration. The direct physical effects of these parameters can be condensed into a physically meaningful expression known as dynamic fluence (in units of J/mm²), which is expressed as follows, assuming Z/Z₀>>1 (where Z₀=0.02 inches) (Eq. 1):

$$Dynamic fluence = \frac{Laser Power}{Scan speed \times Beam diameter} ∝ \frac{Laser Power}{Scan speed \times Z} \qquad ( 1 )$$

However, as evidenced by previous work, such parameters, with the rapidly changing properties of the host polymer itself as it chemically reduces, ablates, or changes in volume, quickly increases the complexity of the problem. This lends itself to modelling the system as a simple set of input machine parameters and a rapidly testable output.

With this information in mind, we designed our procedure. We start by making small, square test-areas using a set of 20 input parameters, and we probe the linear resistance of the samples across a small square to roughly obtain the bulk resistance of the lased sample (where unlased, TS-PAN is non-conductive). The resulting R values are input into the BO algorithm (FIG. 1B) to suggest parameters to further explore the search space, or to exploit a specific set of successful parameters. The process is repeated for several cycles until optimized parameters are found (FIG. 1C). Then, the optimized parameters are used on both sides of the PAN membrane to allow for a fully conductive slab (FIG. 1D), which is then used for electrochemical testing (such as cyclic voltammetry with a redox couple, or RFB cycling) (FIG. 1E).

### Using Bayesian Optimization to Find a Sheet Resistance Optimum

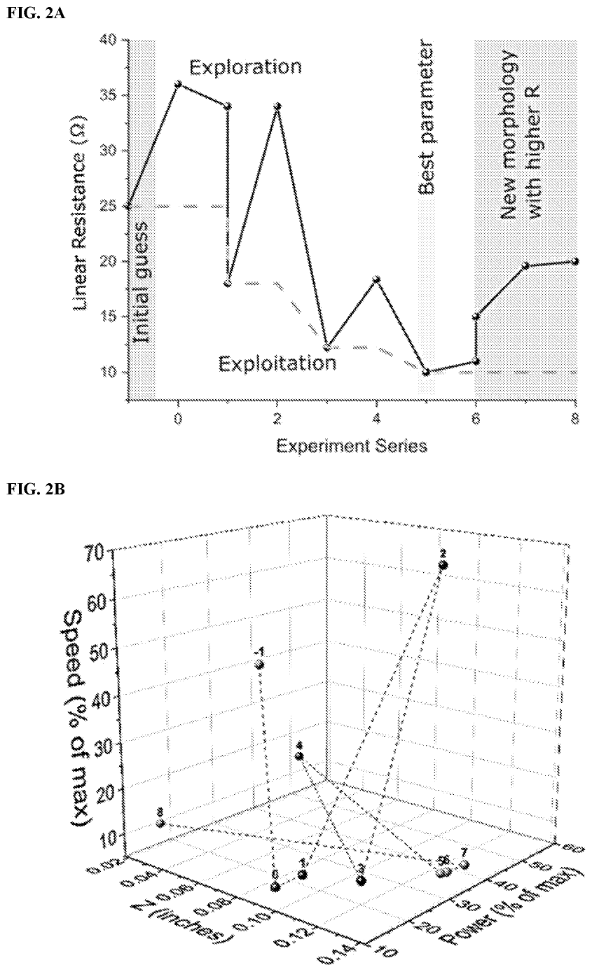

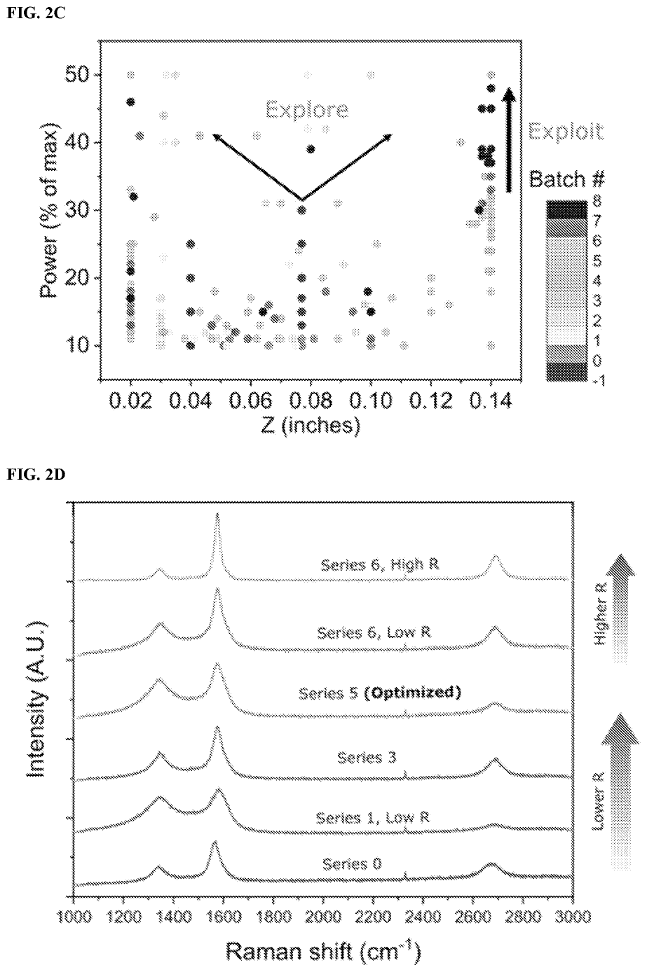

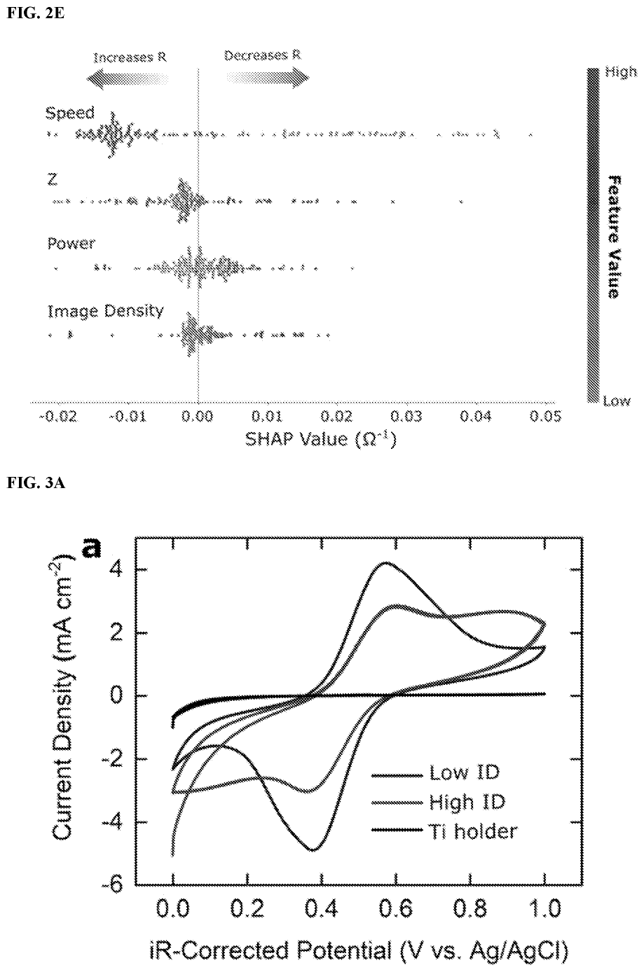

In this work, we use BO to optimize the lasering conditions for PAN. As mentioned in the Introduction, BO is composed of two basic steps: exploitation and exploration. As shown in FIG. 2B, we perform parallel optimization, which improves communication efficiency between computers and experimental agents. In each batch, BO suggests 20 candidate lasing conditions to test, and after the experiments in the current series, 20 more experiments are suggested for the next experiment series. These points are then added to the dataset of lasing conditions and corresponding R.

For context, a conventional experimental setup such as the one to optimize the conductivity for GO would seek to use the following methodology: (1) perform a reasonably large and coarse parameter sweep to identify potentially promising areas of exploration, (2) choose the most successful parameter set and home in on those specific sets, and (3) find a resistance minimum based on trends that are observable across the different variables in question. This method can also be informed by physics, which would imply that single variable and 2-variable dependencies can be inferred. However, unless significant time is invested into this method, it would generally only lead to a single parameter set explored and exploited. The optimized parameter set is system specific, but the general first and second order trends (such as the effect of one variable, or the combination of two interdependent variables) can be transferred to similar materials systems. Therefore, from our previous knowledge of the graphene oxide system, our process is relatively well-informed, but we anticipate that our overall approach of BO and neutral networks (NN) is generalizable to any unexplored system. Moreover, if the results have a higher dimensionality of interesting properties than what is actually measured (i.e., if we only evaluate resistance as a baseline requirement, but are looking to explore more resultant properties of the system such as morphology, electrochemical activity, and chemical properties which are harder to evaluate or measure)—our method can be used to sufficiently map the area.

FIG. 2A shows the evolution of the lowest R during the BO, and we can see that the lowest R is achieved at iteration #5 with R=10Ω. The subsequent points show that the computationally guided approach diverges as it attempts to further optimize R, which yields higher R with different morphologies. FIG. 2B shows the evolution of the parameters that result in the lowest R in each iteration. The evolutions of the best parameters show the combination of exploration (large jumps) and exploitation (small changes) in the optimization process. The full set of 204 points explored in this study is displayed in terms of power and speed in FIG. 2C, from which one can see the exploration direction, from low power, medium z region to medium power, highest and lowest Z region. Moreover, FIG. 2C shows that, after iteration #4, BO extensively exploits the region with highest Z (the region with lowest R).

A few phenomena and morphologies occurred during the optimization. The first phenomenon that emerged during the experiment was called the “burnout” regime. This was observed at high powers and low speeds, which were in the direction that the BO algorithm initially optimized for, where a high degree of ablation was observed, which removed a large fraction of the material, but in some cases, left a conductive sheet of material which was brittle. This resulted in material with large cracks across the entire sample, which meant that it resulted in an electrically discontinuous sample. With even higher powers, the entire material was physically discontinuous, and therefore R could not be measured. A “burnout” sample was therefore designated as an undesirable result, since it would not be useful for the RFB application—as this application needs both high conductivity and electrochemical activity, rather than just conductivity at the expense of electrode active surface area. Starting from iteration #3, we begin to observe burnout. Since we aim to avoid burnout, we set the R of the burnout cases to be 10⁶Ω to force the BO optimize away from the burnout region. However, R of the burnout cases are quite low strictly from a resistance measurement perspective. For example, for the parameter set of (Z=0.14, ID=5, Power=35, Speed=10), although it results in burnout, the measured R along one axis is 9.3Ω, which is even lower than the lowest R reported above.

Because of the assignment of large R to the conductive burnout cases as mentioned above, and because of the non-linear relation between each individual parameter and R as shown below, the underlying function between the four parameters and R is highly non-linear. Therefore, the GP used in standard BO might not capture abrupt transitions in a non-smooth function. Designing GP for non-smooth functions is still in development, and there is no general and easy-to-implement guideline for fitting highly non-linear functions by GP. As an easier-to-implement alternative to designing specific and potentially very complicated GP for this work, here, after iteration #3, we use a NN approach that is thought to have strong expressive power for non-linear relations to help drive exploitations in high Z regions. After each iteration, we use the updated dataset to train a GP by the standard BO package, and also train a NN, and we replace some of suggested parameters from GP by that from the NN to avoid points which are intuitively likely to result in burnout (i.e., replacing high power, low speed points suggested by GP with high Z points suggested by NN). As a result, the parameter that results in the lowest R is discovered by the NN—but parameter sets to explore were still provided by GP. More discussions about the role of NN in this work are provided in the Supporting Information.

At iteration #3, we expand the search space of Z from [0.03″, 0.10″ ] to [0.02″, 0.14″]. The motivation for the expansion is that, at iterations from #0 to #2, the lowest Rs are all observed at the boundary of Z=0.100 inches. As a result, we observe lower Rs after the expansion, and the lowest R is observed at Z=0.138 inches. As previously noted, the dynamic fluence of a particular set of parameters is proportional to the Power:Z ratio, which can remain fixed even as Z is expanded. Therefore, to maintain energy efficiency of the process, we limit further expansion of the Z limit—since energy efficiency is key to reducing the operating costs of the overall fabrication process. Despite the current trend of autonomous optimization of experiments, here we suggest that human monitoring and modification might still be necessary. This is evident due to the following interventions: (1) assignment of large R to burnout cases, (2) the use of NN for exploitation, and (3) the expansion of search space during the optimization. However, the benefit of the mixed BO and NN process is the discovery of two parameter regimes which unlock distinct morphologies as observable by Raman spectroscopy. The evolution of the parameter set resulting in the lowest R in each batch of 20 samples is shown in FIG. 2D.

To further understand the role of each parameter in determining R, we plot the impact of each parameter on 1/R (also known as SHAP value) for all the 204 data points in FIG. 2E. Based on empirical observation informed by the physical insight of the dynamic fluence, we see that higher speed leads to higher R, and higher values of Power and ID have either a strongly positive or strongly negative effect on the final R. From a physical perspective, high power and ID samples are more likely to approach a regime of full graphitization/carbonization which is desirable from the conductivity perspective. However, they are also more likely to result in ablation with the incorrect corresponding parameters. The speed result corresponds specifically to the fact that slower speeds ensure a more even morphology across the sample, which improves the electrical connectivity between regions.

Since the 2-point linear resistance of samples is correlated, but not necessarily equivalent, to the sheet resistance metric, select samples were tested with a van der Pauw (vdP) method to obtain the electrical properties of the network without series and contact resistance corresponding to the poor interface between the probes and the porous network (procedure described in the Methods section). The lowest demonstrated sheet resistance obtained through this method was 6.5 Ω/sq, which is the lowest reported sheet resistance to date for laser-reduced synthetic polymers with single-lasing.

### Electrochemical Properties of Optimized Electrodes

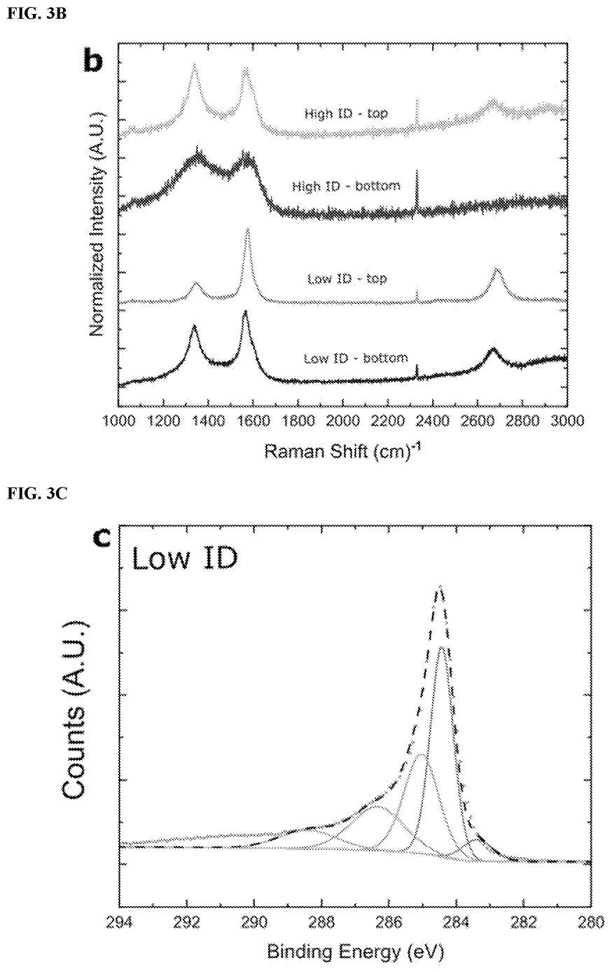

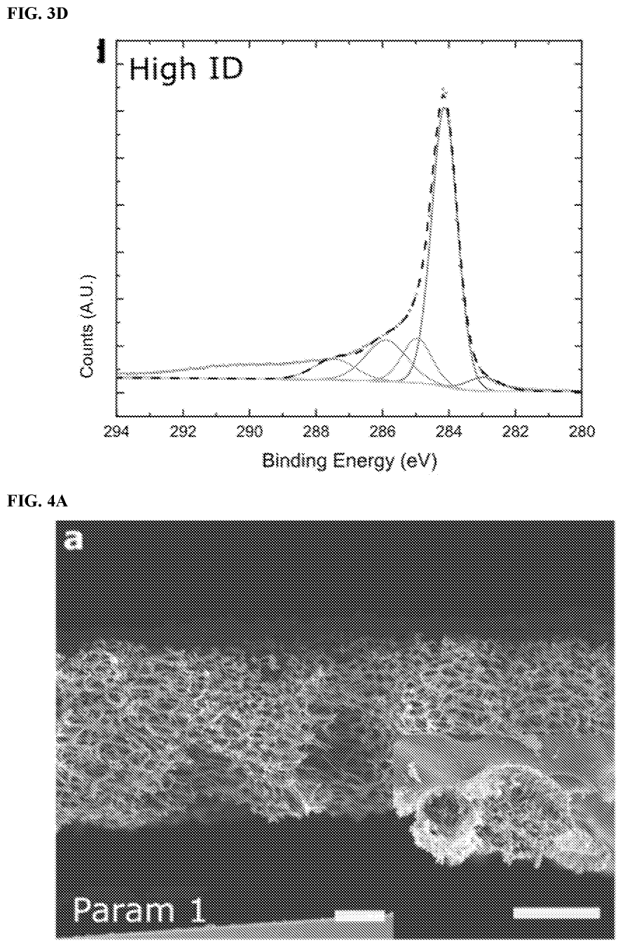

While the material sheet resistance and electronic conductivity are indicators of electron transfer capabilities, we sought to confirm the electrochemical performance of lased electrodes optimized for sheet resistance. To this end, cyclic voltammetry (CV) was performed in aqueous iron chloride solution, as it has moderately fast kinetics and is a redox couple that holds promise as a low-cost, abundant electroactive material. In these experiments, the working electrode was one of the lased electrodes optimized for lowest sheet resistance (Low ID or High ID). The electrolyte composition was aqueous 50 mM Fe²⁺ and 50 mM Fe³⁺ in 1 M KCl supporting electrolyte. FIG. 3A shows representative voltammograms for two optimized parameters, Param A and Param B, at a 5 mV s⁻¹ scan rate. Encouragingly, both samples show electrochemical activity as evinced by well-defined peak currents in the CVs. While the location of the prominent Fe²⁺ oxidation and Fe³⁺ reduction peaks (ca. 0.59 V and 0.37 V vs Ag/AgCl in 3 M NaCl, respectively) are similar for both samples, Param A exhibits sharper and more distinct currents at redox peaks than Param B, indicating higher electrochemical activity. We note that the results of the CVs are to be taken semi-quantitatively due to convoluting factors that complicate interpretation of definite electron transfer rates for non-planar and porous substrates during potentiodynamic measurements.

To rationalize the differences in electrochemical activity, we performed ex situ Raman spectroscopy on Low ID and High ID samples. Comparison of the Raman signatures of the top and bottom of the lased electrodes in FIG. 3B reveals that the electrodes exhibited different degrees of graphitized and carbonized content; in particular, Low ID had an intermediate of graphitic and amorphous content relative to High ID, which was highly carbonized at both edges. The combination of graphitic and amorphous physicochemical property in carbon-based materials has been shown in previous works to improve electrochemical activity.

FIG. 3C shows high-resolution XPS scans of the laser-reduced electrodes, showing a marked difference in carbon signatures. In order of increasing binding energy, the peaks are attributable to carbides, C═C, C—C, C—O, and C═O bonds. The main peaks of interest are the C═C and C—C compared with other binding states, which clearly show a high degree of reduction and carbonization for high ID electrodes, while the XPS denotes a lower degree of overall reduction for the low ID electrodes. This observation is further justified by dendritic structures seen at the surface of lased portions which give rise to the low D and pronounced 2D peaks which are observable in Raman, and also evident from the higher current density from the CV plot. Higher ID values tend to cause more ablation, and therefore are less likely to preserve highly graphitic features.

### Materials Properties of Optimized Electrodes

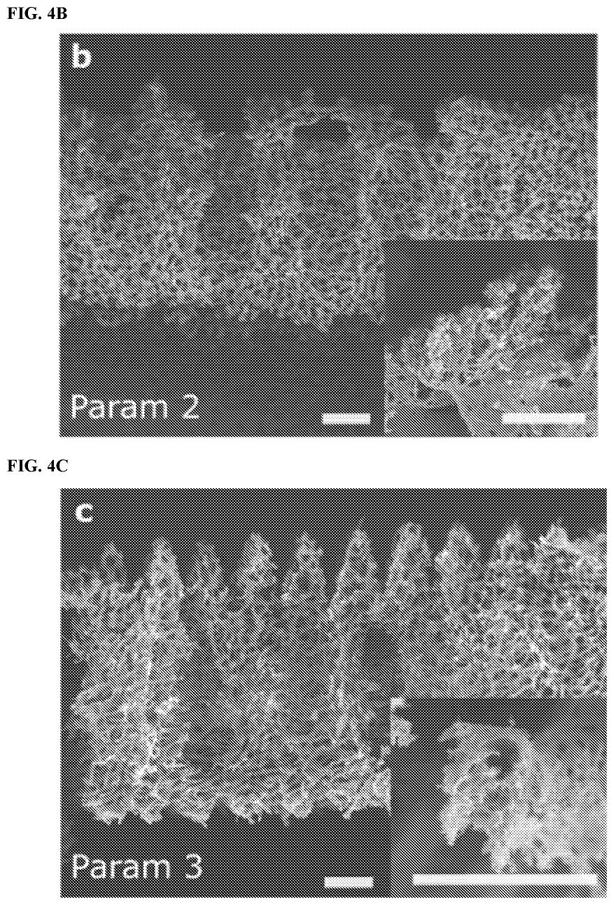

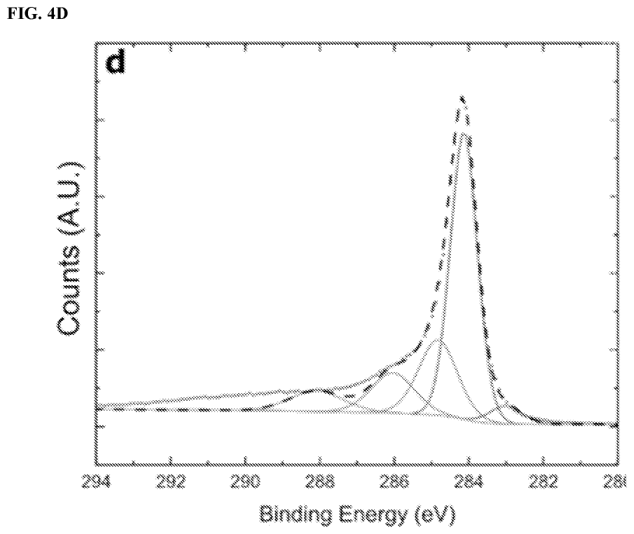

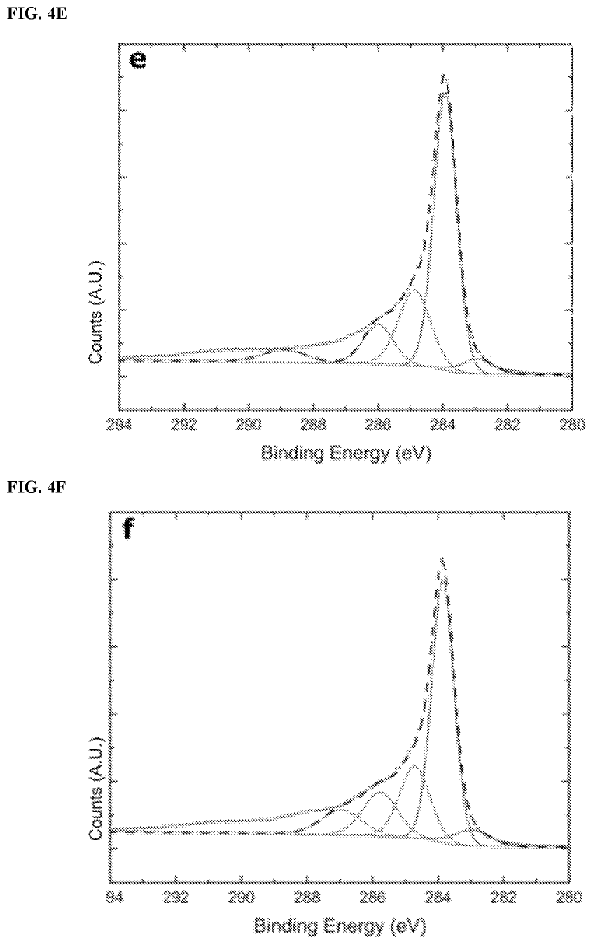

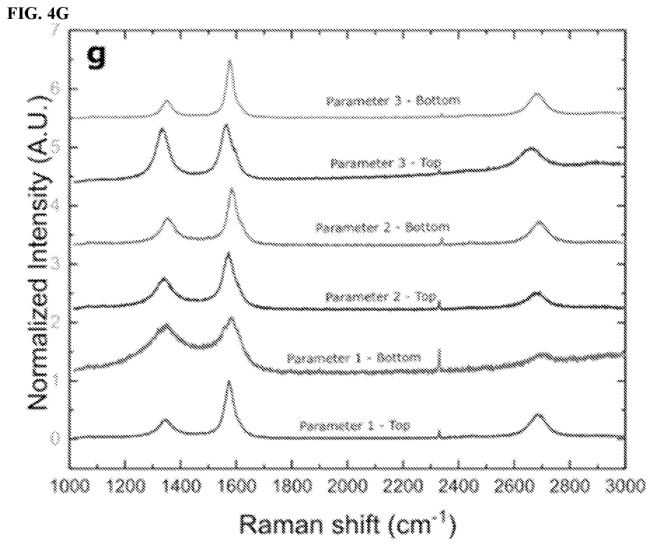

As shown in the previous section, the best parameters tend to have an intermediate between low ID and high ID, where a continuum between the optimized parameters explored in FIG. 3 were explored for Parameters 1, 2, and 3, respectively. The cross-sectional images in FIG. 4A highlight the stark morphological differences that result from modulating the different laser parameters. In each parameter, graphitic dendritic structures are visible at each electrode edge, indicating a possible increase in edge sites, which can increase the electrochemically active surface area, as well as lower the redox overpotential of certain electrochemical reactions. However, the final performance in redox flow batteries depends on a variety of factors, which will be discussed in the following section. The morphologies of the electrodes as a result of using different Z. Power, and Speed parameters shows that there are differences in morphology and final electrode thickness which result from lasing the porous electrode, further complicating the final insights that could be drawn from the single variable used in BO. FIG. 4B shows the similarity in overall oxidation states in each of the lased electrodes, and FIG. 4C shows the progression of the 3 Parameters, from more carbonized to more graphitic.

Parameter 1 has the highest degree of ablation, considering the high power applied (albeit with a high defocus, which reduces the dynamic fluence sufficiently). From the Raman signal, it shows a high degree of carbonization and some high-quality graphitization, indicative of the condition being close to the ideal lasing threshold. This results in a high-performance electrode with poor stability (which is discussed in the next section). Parameter 2 has a lower power, but lower z value, which causes the dynamic fluence to be in the required threshold value. This means that the surface is more highly graphitized while minimizing ablation (as seen by the higher thickness). The disadvantage is that this may cause some regions to remain unannealed, thus increasing the conductivity and reducing electrochemically active surface sites for the electrode. Lastly, Parameter 3 has a slightly higher power and slightly higher speed value, to compensate for ablation caused at higher speeds. However, this strategy is ineffective, as this Parameter yields the poorest results across all 3 electrodes. This reflects general trends observed in a previous systematic study about polyimide laser annealing, where a moderate power maintains a moderate I_{2D}/I_{G} ratio while minimizing the I_{D}/I_{G} ratio.

Due to the high degree of rapid chemical reduction experienced by PAN through this process, there is a marked degree of nitrogen content (as shown in the SI), but this effect has been investigated in previous work with other N-containing polymers and can be minimized with further parameter optimization. The graphitic quality achieved in this work is comparable with previous works using laser reduction on polymers and graphene oxide, but the sheet resistance reported in this work is the lowest for synthetic polymers, exceeded only by Tour et al. with organic char which demonstrated 5 Ω/sq. Additional optimization can be achieved through introduction of multiple lasing steps, through exploring additional PAN thermal stabilization temperatures, or through additives that can incorporate dopants or improve graphitic quality (such as urea for N-doping, or hexamethylbenzene to increase graphene flake size). However, these are associated with either increased costs or lower performances specifically for the RFB application. Guided by BO, we discover multiple lasing regimes (which modulate power, speed, and image density), where we can select Parameter 1 or 2 for further optimization.

### Applications of Laser-Annealed Electrodes in Redox-Flow Batteries

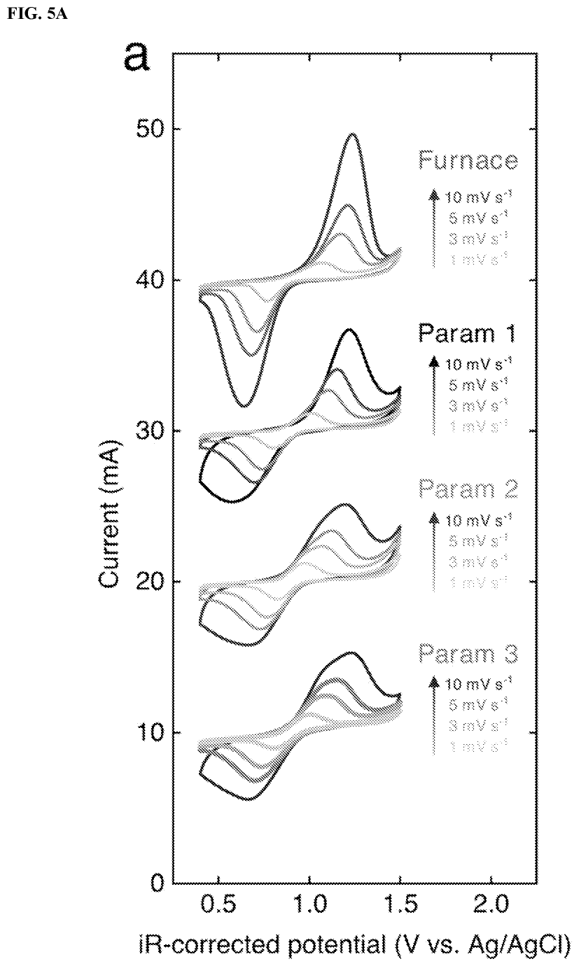

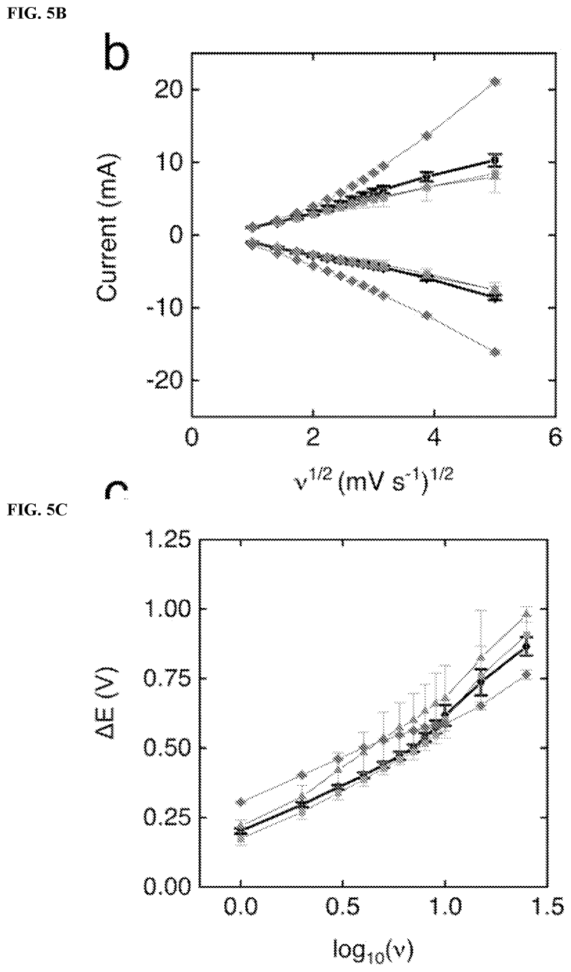

To demonstrate the use of laser-annealed electrodes in electrochemical applications, we sought to evaluate the electrode performance in a practically relevant redox system, the vanadium redox flow battery (VRFB). The majority of research and commercialization efforts have focused on the VRFB due to its unique feature of utilizing multiple oxidation states of the same parent compound for both the negolyte and the posolyte, enabling low-cost capacity fade remediation through rebalancing (i.e., remixing and recharging the electrolyte), an inexpensive, simple, and automatable process. CVs were performed in 50 mM V(IV) and 50 mM V(V) in 3 M H₂SO₄ supporting electrolyte to screen electrode electrochemical activity; further details can be found in the Methods section. FIG. 5A shows iR-corrected CVs of the lased electrodes at scan rates of 10, 5, 3, and 1 mV s⁻¹ for Param 1, Param 2, Param 3, and conventional furnace carbonized electrodes. The CVs show large peak-to-peak separation, in agreement with the complex and sluggish kinetic behavior typically observed for vanadium redox reactions. The peak current as a function of square root of the scan rate shown in FIG. 5B suggests that the furnace activated electrode showed the highest electrochemical activity of the set, based on the larger magnitude of both the anodic and cathodic current responses at all scan rates. We attribute the non-linearity in the current vs square root of the scan rate to be a consequence of potentiodynamic measurements in a three-dimensional, hierarchical porous structure, whereby diffusive length scale may vary as a function of scan rate. Similarly, the peak-to-peak separation of the iR-corrected CVs, ΔE, increases non-linearly with increasing scan rate for all electrode sets (FIG. 5C); the increase in ΔE with scan rate at these conditions suggests quasi-reversible and irreversible behavior. Generally, reduced ΔE correlates to greater reversibility; from this qualitative assumption, Params 1 and 2 showed better performance than Param 3, which was closer to the initial set of variables from Iteration −1 in the BO step.

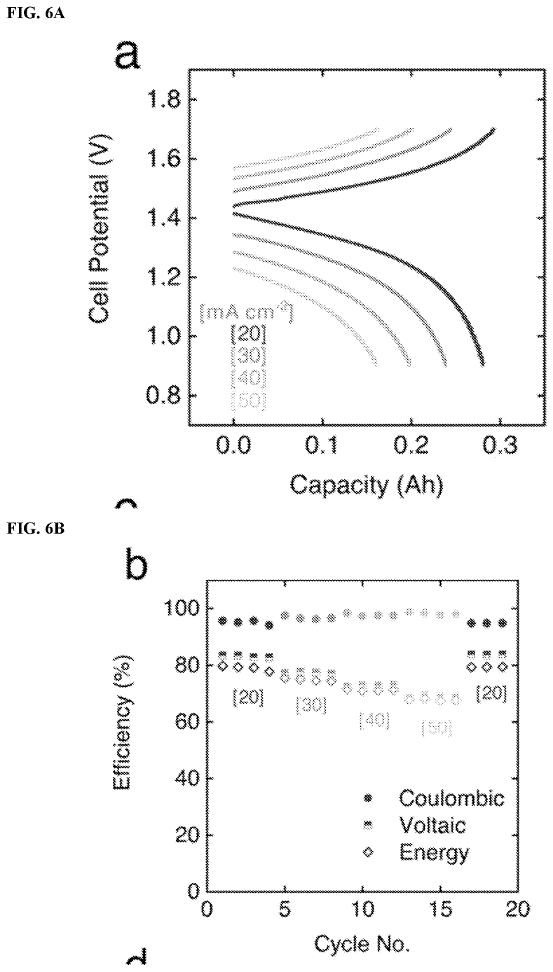

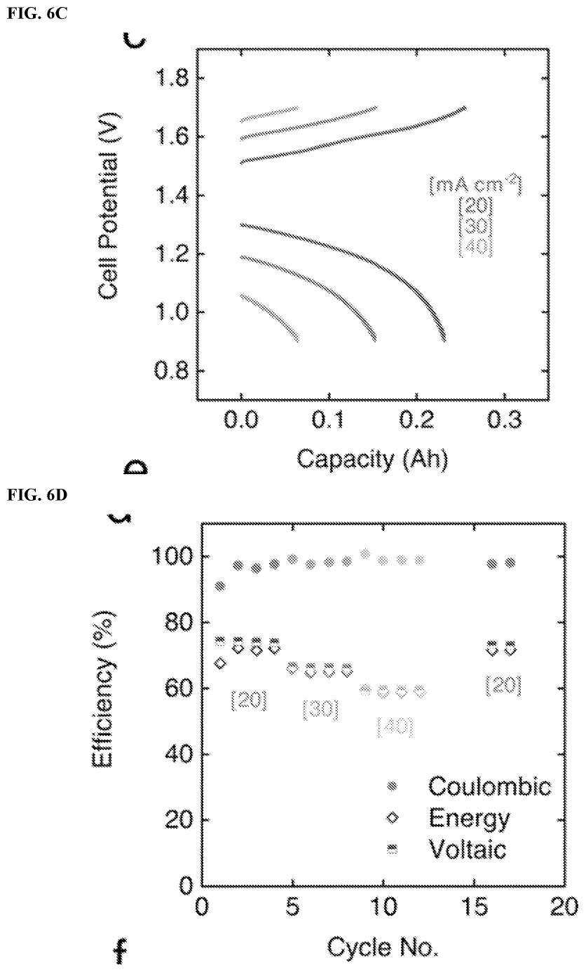

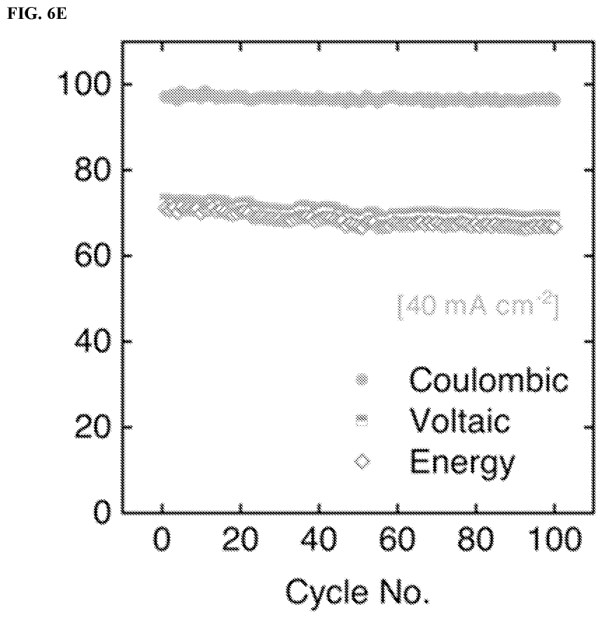

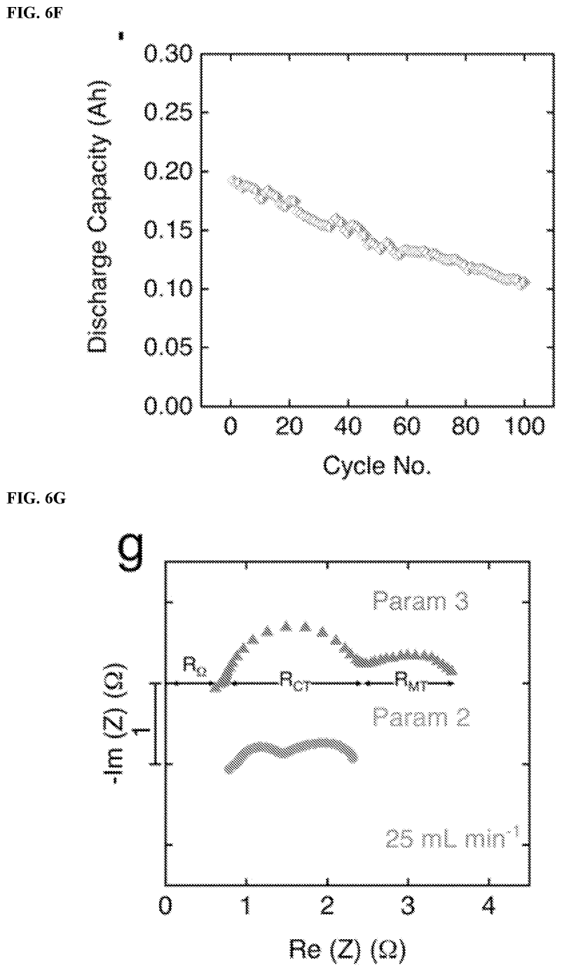

Based on promising physical and electrochemical characteristics, the electrodes laser-annealed using Parameters 2 and 3 were evaluated in a single-cell VRFB (FIG. 6). Specifically, the cells were galvanostatically cycled at 20, 30, 40, and 50 mA cm⁻², and then were returned to 20 mA cm⁻² Param 2 had coulombic efficiencies (CEs) that ranged from 94.8-98.3%, while Param 3 comparably had CEs range from 95.7-99.3%. Param 2 achieved higher energy efficiency (EE) than Param 3 at all current densities; specifically, Param 2 reached an EE 67.8% at a current density of 50 mA cm. Furthermore, upon return to a less demanding current density of 20 mA cm⁻², Param 2 recovered performance, suggesting good stability. To further assess the cycling stability of the lased electrodes, Param 2 was cycled at a moderate current density of 40 mA cm⁻² for 100 cycles; the resulting efficiencies and discharge capacity are shown in FIG. 6E. The lased electrodes are stable over the ca. 2-week duration as evinced by low cell performance fade. The observed discharge capacity fade (FIG. 6F) is posited to be largely due to active species crossover or cell-level imbalances as opposed to electrode degradation. An electrolyte utilization of ca. 49.7% is reached; here, electrolyte utilization is defined as the experimentally determined discharge capacity divided by the theoretical discharge capacity (0.40 Ah for 15 mL of electrolyte). We note that while the observed roundtrip efficiency and discharge capacity achieved is relatively low compared to state-of-the-art electrode architectures, further optimization on cell architecture (i.e., active area geometry, electrode compression, flow field design), operating conditions (i.e., electrolyte compositions, flow rates), and lasing parameters focused on enhancing electrochemical properties will lead to enhanced performance in future studies. Nyquist plots from electrochemical impedance spectroscopy (EIS) of Param 2 and Param 3 electrodes at a flow rate of 25 mL min⁻¹ are shown in FIG. 6G. The area-specific ohmic resistance, R_{Ω}, can be determined from the high-frequency intercepts of the Nyquist plots. Membrane resistances, electrode resistances, leads, and cell architecture contribute to Rn. Here, we find that both Param 2 and 3 have Rn of ca. 0.87 and 0.69Ω (2.22 and 1.76 Ω cm²), respectively. These values, while slightly higher than the ohmics of furnace derived phase separated electrodes and commercial materials, are within reason for cell operation; further optimization on factors that impact cell resistances, such as the compression ratio, are posited to further reduce ohmic resistances. The high-frequency semicircle corresponding to charge-transfer resistance is smaller for Param 2 than Param 3, indicating Param 2 had improved kinetics relative to Param 3. In both electrodes, increasing the flow rate led to a reduction in the size of the lower frequency loop corresponding to mass transfer resistance. Overall, Param 2 showed smaller overall resistances compared to Param 3, corroborating the galvanostatic cycling results.

Overall, this study explores the start of optimizing the laser-annealing parameters for PAN-based membranes, and it is motivated by the potential energy, cost, and emissions-savings associated with using optical annealing instead of furnace-based annealing. The efficiency of the laser-based processing lies in using optical absorption, rather than thermal conduction, to achieve the high temperatures required to transform polymers into conductive carbonaceous materials. The capital costs and maintenance costs of operating a commercial thermal oven are higher than using a low-power laser-annealing setup, as long as the electrodes are sufficiently thin to be processed using a laser. To evaluate the technoeconomic opportunity of transitioning to laser-processing for RFB electrode manufacturing, using PAN as a starting material, we roughly compare the equipment cost and energy consumption of lab-scale equipment. To thermally stabilize PAN, 82 MJ/kg_{PAN} is required as energy input, based on the assumption that the energy consumption of the process is linearly proportional to the temperature required (which is likely an under-estimation of the real energy consumption, since there are practical inefficiencies that arise when considering higher annealing temperatures). Based on this assumption, thermally annealed membrane electrodes (annealed at 1,050° C., based on the previously reported procedure) would require a total of 578 MJ/kg_{PAN}. For laser-processed electrodes, since we explore a variety of operating conditions, two cases with two separate ID and Power values are stipulated. The worst case corresponds to 30% Power. ID=6; and the best case corresponds to 15% Power, ID=4; (with the speed fixed at 10% for both cases). These result in a range of 36-214 MJ/kg_{PAN}, which means that with further optimization, there is an opportunity to reduce the energy consumption of the carbonization process by 2-16 times the current standard required. This reduced energy requirement could not only reduce the overall energy costs but can also reduce other capital and operating costs associated with power electronics, maintenance, and labor required to operate high-temperature equipment. Moreover, future work should focus on reducing the dynamic fluence (i.e., reduce power and ID, increase speed) to realize the benefits of lower-energy manufacturing of carbon electrodes.

### SUMMARY

This work demonstrates several avenues of fundamental progress in processing PAN for electrochemical applications. We demonstrate that using the strategies of microstructuring, thermal stabilization, and BO, are crucial to arriving at a suitable set of parameters to realize porous carbon electrodes processed at <300° C. Our approach starts with a careful investigation of the initial conditions and previous knowledge of laser-reduction of polymers and graphene oxide, followed by a BO which explores the parameter space in ways that yield unexpected morphologies at parameter combinations that would have otherwise been thought to lead to undesirable results. However, we also show that in our specific study which only uses linear resistance as a rapidly testable measurement to inform BO, we need additional intervention through expanding testing boundaries and introducing a NN to exploit successful parameters. The resulting parameters yield the lowest sheet resistance value reported to date (6.5 Ω/sq) for a commercial polymer, using PAN: a polymer that was previously reported to be unlaseable in its native form. The resulting parameter sets are further leveraged for VRFBs, where they demonstrate reasonable performances despite minimal trial-and-error in electrochemical experiments, where we envision that laser processing can result in significant energy savings in carbon electrode manufacturing. Overall, this work motivates future studies on BO used for exploration of parameter spaces to discover new morphologies, as well as continued optimization of porous laser-reducible polymer scaffolds for electrochemical applications including RFBs.

### Methods

### Synthesis of Phase Separated Membranes and Electrodes

Briefly, polyacrylonitrile (PAN, MW˜150,000 g mol⁻¹, Sigma Aldrich), polyvinypyrrolidone (PVP, MW˜1,300,000 mol-1. Alfa Aesar), and N,N-dimethylformamide (DMF, for HPLC, ≥99.9%) were mixed together in a glass reservoir. A typical composition consisted of 6.4 g PAN, 9.6 g PVP, and 80 mL of DMF, leading to 17.5 polymer weight percent, or 0.20 g polymer per mL of solvent. To ensure uniform mixing of the reagents, the mixture was heated and stirred at 70° C. until a homogeneous, viscous, and clear polymer solution was obtained. Three aluminum molds, each machined to contain notches 10×5 cm wide and 0.1 cm deep, were arranged onto a glass plate. Polymer mixture was poured into each aluminum mold and dispersed evenly across the notches using a glass slide. The casted polymers were then rested in ambient conditions for ca. 15 min; during this step, humidity from the ambient environment leads to vapor induced phase separation at the non-solvent/solvent interface, preventing an impenetrable non-porous dense layer from forming. After resting for the prescribed time, the glass plate with the aluminum molds is submerged into a coagulation bath consisting of 3 L of deionized water to initiate the phase separation process. After phase separating overnight, the membranes are removed from the aluminum molds, and repeatedly soaked in fresh boiling water until the added water becomes completely clear; this process maximizes the likelihood that PVP and DMF are eliminated from the pores of the PAN membrane.

Following phase separation, the membranes were dried under vacuum overnight at ca. 80° C. to remove residual non-solvent. Then, the electrodes were thermally stabilized in a Bamstead Thermolyne muffle furnace. The temperature was ramped at 2° C. min⁻¹ from room temperature (ca. 23° C.) to 270° C., where it was held for 1 h, and allowed to cool back to room temperature without further intervention. For the furnace carbonized samples, the thermally stabilized materials were inserted into a Carbolite Gero GHA 12/300 and carbonized under flowing nitrogen with the following programming sequence: ramp 5° C. min⁻¹ from room temperature to 850° C., hold for 40 min at 850° C., ramp from 850° C. to 1050° C., hold for 40 min at 1050° C., cool down to room temperature without further intervention.

### Laser Processing of Membranes and Physiochemical Characterization

Electrodes are laser processed with a VersaLaser VLS2.30 (Universal Laser Systems) with a 10.6 μm CO₂ laser. Parameters which are optimized include (1) Laser Power, which is modulated as a percentage of 25 W; (2) Laser speed, which is a percentage of 1270 mm/s; (3) Image Density, which indicates the vertical line density in a given scan—where an Image Density of 6 corresponds to 1000 DPI (the horizontal pixel density is fixed at 1000 DPI): (4) Z-height, which indicates the degree of defocus relative to the sample. The samples are approximately 0.02 Inches thick, which means this is where the surface of the sample is perfectly in focus, and any higher settings indicate a defocusing of the laser spot. The initial search space for Z was restricted to 0.10 inches, which was expanded to 0.14 inches in the final procedure. A constraint was set, since defocusing necessitates an increase in power at a specific laser point, which reduces the energy efficiency of the process. Once the membrane areas were patterned, the resistance of the samples was measured from the edges of the patterned area with a multimeter. The measurements are taken across opposite edges and the final R value is listed as the average of the two readings. This is also illustrated in the lower power requirements for a Z-height of 0.02 inches, compared to 0.139 inches. All samples were patterned on the “Top” surface, which was designated as the dense layer of the PAN membrane. For double-side patterned membranes, both the “Top” and “Bottom” surfaces were patterned. The list of best explored parameters from each Experiment Series are listed below in Table 1.

TABLE 1
List of all parameters explored using
BO (also depicted partially in FIG. 2).

| | | | Power | Speed | |
|---|---|---|---|---|---|
| Experiment | Z-height | Image | (% of | (% of 1270 | R |
| Series | (inches) | Density | 25 W) | mm/s) | (Ohms) |
| −1 | 0.077 | 5 | 20 | 25 | 25 |
| 0 | 0.051 | 6 | 10 | 10 | 36 |
| 1 | 0.100 | 6 | 50 | 65 | 34 |
| 1 | 0.100 | 6 | 16 | 10 | 18 |
| 2 | 0.100 | 6 | 50 | 65 | 34 |
| 3 | 0.120 | 6 | 20 | 10 | 12 |
| 4 | 0.043 | 4 | 41 | 20 | 18 |
| 5 | 0.138 | 5 | 30 | 10 | 10 |
| 6 | 0.139 | 5 | 31 | 10 | 11 |
| 6 | 0.140 | 7 | 18 | 10 | 15 |
| 7 | 0.137 | 7 | 31 | 30 | 20 |
| 8 | 0.020 | 5 | 17 | 10 | 20 |

A set of 20 measurements is performed, and the sample with the lowest resistance was further characterized with Raman spectroscopy (Renishaw Invia Reflex Raman Confocal Microscope, 50 mW, 532 nm laser, 10× objective lens). At later series, multiple samples were analyzed due to similar R measurements resulting from very different parameter sets. The final membranes were additionally characterized using Scanning Electron Microscopy (Zeiss Gemini 450) and high-resolution X-ray Photoelectron Spectroscopy (Thermo Fischer Nexsa) with a flood gun for charge correction, and Shirley background correction on obtained spectra. For electrochemical evaluation, the following parameters were used to prepare membranes for testing (Table 2).

TABLE 2
List of Parameters tested electrochemically
(as represented in FIGS. 3 and 4).

| | | | | Power | Speed |
|---|---|---|---|---|---|
| | Lased | Z-height | Image | (% of | (% of 1270 |
| Label | Side | (inches) | Density | 30 W) | mm/s) |
| Low ID | Top | 0.139 | 5 | 31 | 10 |
| | Bottom | 0.02 | 4 | 15 | 10 |
| High ID | Top | 0.14 | 7 | 10 | 15 |
| | Bottom | 0.14 | 7 | 10 | 15 |
| Parameter 1 | Top | 0.139 | 5 | 29 | 10 |
| | Bottom | 0.139 | 5 | 29 | 10 |
| Parameter 2 | Top | 0.02 | 5 | 17 | 10 |
| | Bottom | 0.02 | 5 | 17 | 10 |
| Parameter 3 | Top | 0.077 | 5 | 20 | 25 |
| | Bottom | 0.077 | 5 | 20 | 25 |

To compare the linear resistance measurement to previously reported values, we perform a sheet resistance measurement through the vdP method. 1 cm² laser reduced samples were prepared with the following parameters ([Z, ID, Power, Speed]) Parameter A: [0.077, 5, 20, 25]); Parameter B: [0.138, 5, 27, 10]. Then, the sample was cut to shape and secured onto a 1′×3″ glass slide with double-sided tape. Then. 4 copper tape strips were pasted to the 4 corners (1-2 mm from the edge of the lased area) and the contact was reinforced with silver paste (DuPont 4922N-100). This resulted in the following [Rᵢₙ, Rₛₕ] combinations: Parameter A: [35 Ω, 16.3 Ω/sq]; Parameter B: [15 Ω, 6.5 Ω/sq]. Thus, the linear resistance values are generally overestimates of the sheet resistance values in this study, but still serve as a suitable measurement to optimize sheet resistance.

### Ex Situ Electrochemical Evaluation

Cyclic voltammetry measurements were performed in a three-electrode cell with a porous carbon working electrode, an Ag/AgCl in 3 M NaCl reference electrode, and a Pt coil counter electrode. The working electrode was fashioned by sandwiching the porous electrode and a titanium current collector between an acrylic backing plate and an acrylic plate with a laser-cut opening of 0.5×0.5 cm². The iron chloride electrolyte consisted of 50 mM iron (II) chloride tetrahydrate (FeCl₂·4H₂O, 98%, Sigma Aldrich), 50 mM iron (III) chloride hexahydrate (FeCl₃·6H₂O, 97%, Sigma Aldrich), and 1 M potassium chloride (KCl, ≥99%, Sigma Aldrich) dissolved in DI water. The vanadium electrolyte consisted of 50 mM VO²⁺ from vanadium (LV) sulfate oxide hydrate (99.0% metals basis. Alfa Aesar), 50 mM VO²⁺ generated from electrolysis (vide infra), and 3 M H₂SO₄ (95.0-98.0%, Sigma Aldrich). All cyclic voltammograms are iR-corrected to prevent ohmic distortions. Measurements were performed on a VMP3 Bio-Logic potentiostat (Bio-Logic).

### Evaluation of Lased Electrodes in Flow Cell Testing

Single measurements were conducted in a zero-gap 2.55 cm² geometric active area cell, which comprises of porous electrodes, a membrane, and interdigitated flow fields. The electrodes were compressed to ca. 80% of their nominal thickness by selecting gaskets of the required thickness. Vanadium electrolyte was generated via electrolysis; specifically, beginning with starting solutions of 1 M VO²⁺ in 3M H₂SO₄, the cell was held at a potential of 1.7 V until the current plateaued at 10 mA (ca. 3.0 mA cm⁻²). During this process, the negolyte reduces from VO²⁺ to V³⁺, and the posolyte oxidizes from VO²⁺ to VO₂⁺. Subsequently, the posolyte is replaced with fresh VO²⁺, and the cell charged at 100 mA cm⁻² until a cell potential of 1.7 V, discharged at 100 mA cm⁻² until a potential of 0.9 V, and recharged at 100 mA cm⁻² until reaching a 50% state-of-charge, determined coulombically. 15 mL of the resulting solutions were used for the posolyte and negolyte in ensuing electrochemical measurements.

Electrochemical impedance spectroscopy (EIS) at open circuit potential was performed to identify kinetic, ohmic, and mass transport contributions of the flow cell. The frequency ranged from 1 MHz-10 mHz, applied at 6 points per decade with a 10 mV sinus amplitude, and data averaged at 5 measures per frequency. EIS measurements were conducted on a VMP-3 Bio-Logic potentiostat (Bio-Logic). Following EIS, a rate study was performed by charging and discharging galvanostatically at current densities of 10, 20, 30, 40, and 50 mA cm⁻², and then returned to 20 mA cM⁻². Flow cell stability was evaluated by galvanostatically by cycling at 40 mA cm⁻² for 100 cycles. Cutoff cell voltages were placed at 0.9 V for discharge and 1.7 V for charge. The coulombic efficiency is determined as the quotient of the discharge to charge time, while the voltaic efficiency is the ratio of the average discharge voltage to average charge voltage. The energy efficiency is determined as the product of the coulombic and voltaic efficiencies. Galvanostatic measurements were performed on an Arbin battery tester (BTS-200).

### Bayesian Optimization

In this work, because of the large range of R (10Ω to 10⁶Ω), we maximize 1/R as the optimization target. The package EDBO is used to perform the standard Bayesian Optimization. Gaussian Process is used as the surrogate model in EDBO with the Matern Kernel as the covariance function. Expected Improvement is used as the acquisition function. The BO express module of EDBO is used to conduct the Bayesian Optimization, as this module automatically features the reaction space, preprocesses the data and selects the priors for Gaussian Process. For the neural networks used to help exploitation, we use Scikit-Learn to construct 3-layer networks with 16 neurons in each layer and use the “relu” function as the non-linear activation. 10 networks with different random initialization are used as an ensemble, and the predicted values of R are the mean of predictions from the ensemble. For the SHAP values, we first build a decision tree model to fit the dataset, then use the Package SHAP³⁹ to derive the impact of parameters to model output.

The search space for BO is defined as follows: Z∈[0.03, 0.10] inches, with the spacing of 0.01 inch; ID∈{4, 5, 6, 7}: power∈[10, 50]% of 30 W, with the spacing of 1% of 30 W; speed∈[10, 60]% of 1270 mm/s, with spacing of 5% of 1270 mm/s. Therefore, the number of combinations of parameters is 593,844: After expansion, the Z space is expanded to [0.02, 0.14], and the number of parameters increases to 1,012,044.

### Exploration of Laser-Annealing PAN Prior to Structure Optimization

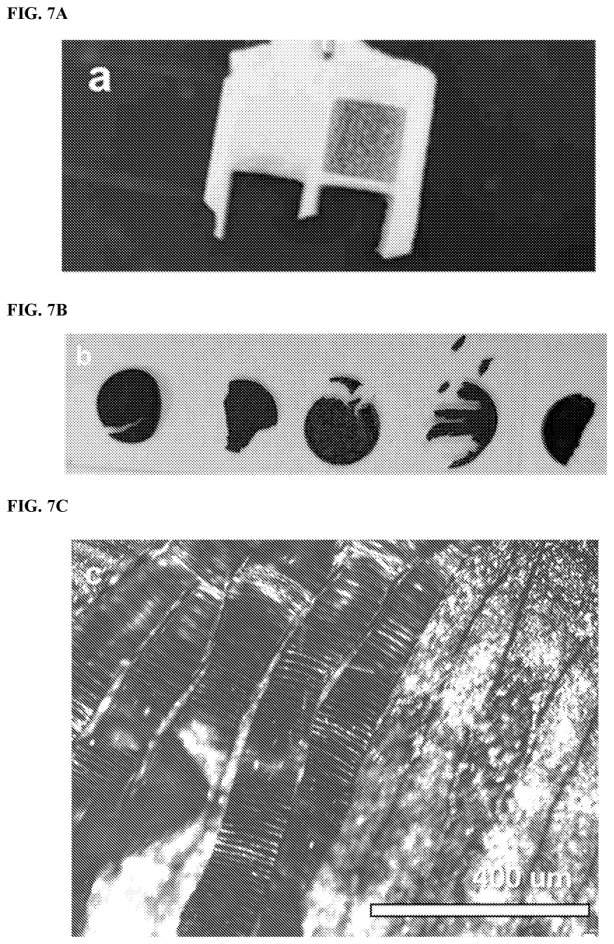

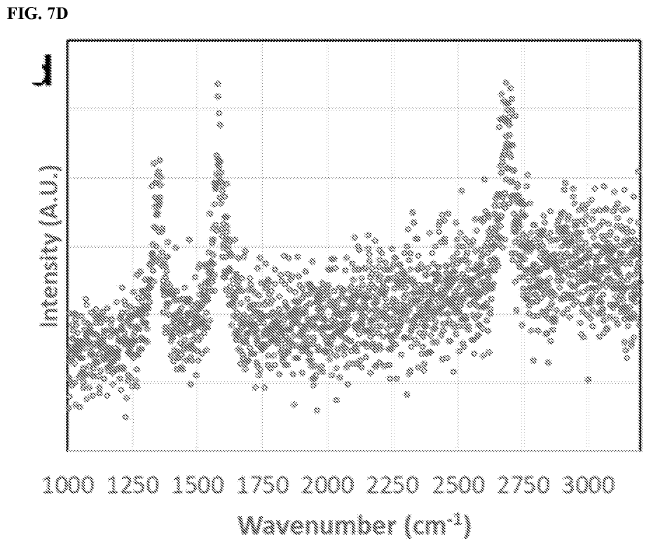

Laser annealing of PAN is challenging and requires careful tuning of parameters and morphology. This balance is illustrated in FIG. 7A, where attempts to laser reduce PAN result in either no changes in the material or result in major or complete ablation. To test whether the material after thermal stabilization would be suitable for reduction, we apply the optimized conditions to 100-um thick solid disks of PAN (FIG. 7B). We observe cracking and/or delamination of material, likely due to the mismatch in thermal expansion coefficients between graphitic material and the starting polymer. Furthermore, the rapid thermal expansion and contraction resulting from the fast laser absorption process further drives potential ablation or delamination, as seen in the optical microscope image in FIG. 7C. However, there was evidence of the overlying material's graphitic nature, as evidenced by Raman signal (FIG. 7D).

### Cost Analysis Comparing Furnace Processing to Laser Annealing

### Costs for Thermal Processing of PAN-Based Membranes

The furnace used in this study is a Carbolite GHA 12/300. The temperature profile consists of a ramp from 25 C to 850 C, hold for 40 min at 850 C, ramp to 1,050 C, hold for 40 min at 1050 C. let cool down to room temperature. Based on the calibration curve. Based on a calibration curve of the working operating percentage, which varies depending on the temperature settings, and assuming that each percentage corresponds to an output of 31.2%, we obtain a final output of 154 MJ per oven run.

The volume of the tube is ca. 2209 cm³; assuming the entire volume of the tube can be used to carbonize electrodes (which represents a large overestimate), and assuming a thermally stabilized density of 0.20 g/cm³ and a ca. 60% mass conversion efficiency from thermally stabilized to carbonized, yields 578 MJ kg⁻¹.

At larger scales, stabilization, carbonization, and graphitization assumed to be 265.0 MJ/kg of felt electrode (this assumed a yield of 50% from PAN to carbonized product). In other words, the energy cost is 530 MJ/kg of polyacrylonitrile. The energy cost of thermal stabilization is not specified, but presumably, it is much lower than that of carbonization and graphitization. A conservative estimate of the conditions associated with this FIG. are as follows: (1) a maximum carbonization temperature of 2000° C.; (2) a linear relation between the energy cost and over temperature, which neglects the penalty of the inefficiency of achieving higher temperatures, (3) assumes the gaseous environment can be easily changed from thermal stabilization to carbonization/graphitization (i.e., switching from air to N₂). The capital cost associated with the lab setup is between 7 000 and 12 000 USD for a Carbolite furnace depending on the specifications needed.

### Operating Costs for Laser Processing of PAN-Based Membranes:

The operating costs of laser annealing depend on the laser power and speed. For the VLSDT 2.30, the experiments use a maximum CO₂ laser power of 30 W (which represents 100% power). To measure the laser processing speed, a speed of 100% (corresponding to a scan rate of 1270 mm/s) is used, with different image densities, to lase a 100 cm² area (10 cm×10 cm). The lasing rate for an ID of 4 and 6 are (3.56 s/cm²)⁻¹ and (10.48 s/cm²)⁻¹, respectively. The areal mass of the electrodes is 10.2×10⁻⁵ kg/cm².

The parameters commonly used are typically less than 33% power, which corresponds to 10 W. Since the electrodes need to be lased from both sides, this corresponds to a maximum power consumption of 20 W. Moreover, the optimum speed is found to be at 10%, which decreases the calculated lasing rate by a factor of 10. However, certain parameters can use much lower powers at around half the nominal value (corresponding to 10 W), which also occur at lower image densities. Therefore, to estimate the range of possible parameters, we calculate the energy consumption of the following [Power; ID] scenarios: [10%, 4] and [33%, 6], which yield 36 MJ/kg and 214 MJ/kg, respectively. The capital cost associated with the lab setup can be between 500 and 10000 USD, depending on the vendor and associated hardware.

### Summary of Cost Considerations

This brief analysis considers only the energy requirements for manufacturing a carbonaceous electrode and shows that laser processing can have as much as a 16× reduction in energy consumption during the carbonization step. Factors that were not accounted for include (1) infrastructure (such as power electronics) which would be needed to support each hardware—which would likely be more intensive for a furnace than a low-power laser; (2) costs associated with maintaining an inert environment for furnace annealing; (3) how other costs like power electronics, maintenance, and labor would affect the price point; and (4) how capital costs may factor into the overall cost of electrode manufacturing. Moreover, the chemicals represent most of the cost for Vanadium redox flow batteries. However, with systems like Fe—Cr flow batteries, where the felt electrodes are a higher proportion of cost, lower cost materials and processing can contribute to reducing the overall cost for smaller-scale flow batteries.

### Neural Networks for Exploitation

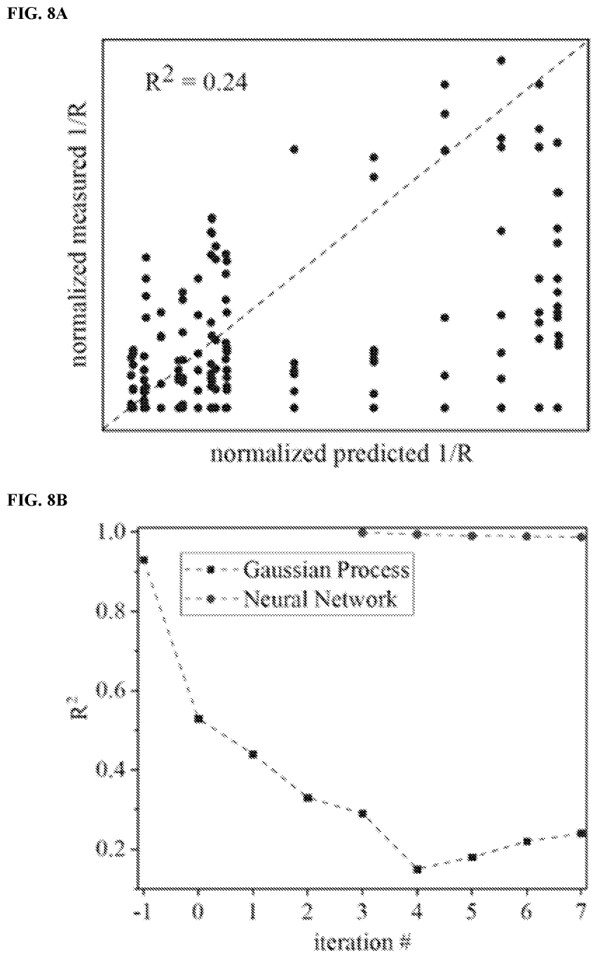

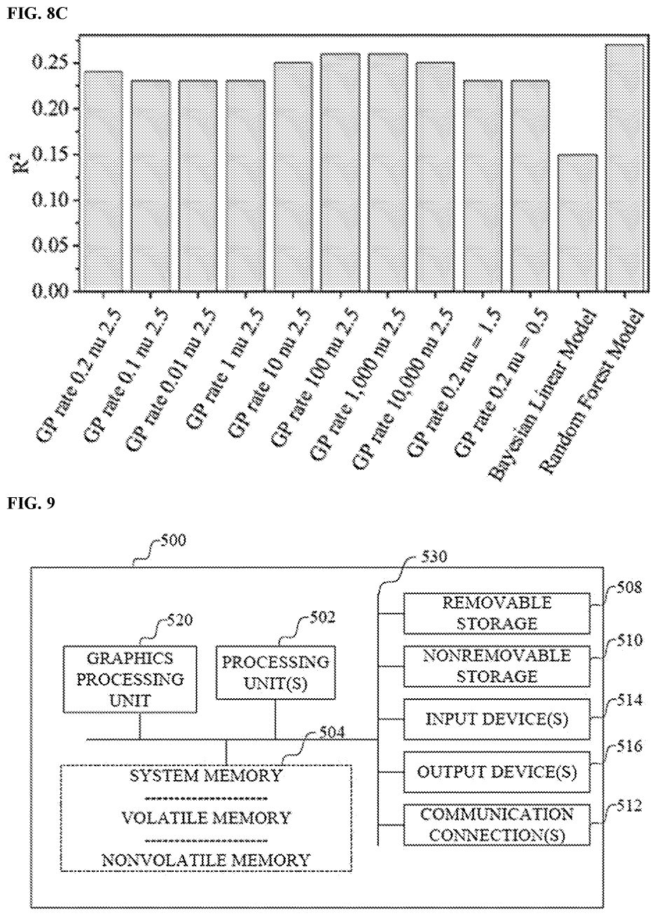

Because of the assignment of large R to the burnout cases, and because of the non-linear relation between each individual parameter and R, the underlying function between the four parameters and R is highly non-linear. Therefore, the Gaussian Process (GP) used in standard BO might not capture the non-smooth function very well. We show the fitting results of the GP implemented in EDBO at iteration #7 in FIG. 8A, from which one can see that the GP cannot fit the dataset very well. Especially, the GP shows a very high false positive rate, or in other words, there are many points predicted to have low R which in turn do not have low R measured in experiments. Such high false positive rate might lower the efficiency of the exploitation step, as many of the predicted low R parameters would result in high R in measurements. In FIG. 8C, we compare other surrogate models available in EDBO for fitting the dataset at iteration #7, including GP with different length-scale priors and nu parameters for the Matern kernel, and Bayesian Linear Model and Random Forest Model. We can see that switching from the automatic setting by EDBO to other models does not improve the fitting performance significantly.

Since designing GP for non-smooth functions is still in development in this work, we use neural networks (NN) to help the exploitation step. We use 3-layer networks with 16 neurons in each layer and use the “relu” function as the non-linear activation. 10 networks with different random initialization are used as an ensemble, and the predicted values of Rs are the mean of predictions from the ensemble. We choose the “relu” function as the activation function, because the dataset has step-function behavior, which partly results from the fact that we assign R=10⁶Ω to all non-conductive samples and burnout cases. As shown in FIG. 8b, the NNs have R2 scores close to 1.0 at all iterations. As a comparison, with the same dataset and other settings of NN, if we switch from “relu” activation to linear activation, the R2 scores would drop to around 0.4, and if we switch to logistic activation, the R2 scores would drop to less than 0.9.

In FIG. 8B, we show the fitting performance of GP and NN during the optimization. For GP, with the addition of new data, the fitting performance first drops quickly and then slowly improves, while for NN, the fitting performance is excellent over the whole process. We argue that, the combination of GP and NN in this work is critical to the optimization, because of the following reasons:
i) Both GP and NN contribute to the discovery of the parameters that result in the lowest R at each iteration. Specifically. NN suggests such parameters with lowest R at iterations #3, #5, #6, and #7, and GP suggests such parameters at iterations #0, #1, #2, #4, and #8. NN discovers the parameters with the lowest R during the whole optimization at iteration #5.
ii) Because of its strong fitting power, NN is very helpful for exploiting the high Z region, as shown in the argument i). However, we cannot rely solely on NN, because even if we use the standard deviation of NN ensembles as an estimation of uncertainty, all the parameters NN suggests to test are concentrated in the high Z region. Therefore, in order to continue the exploration for whole parameter space, GP is still necessary even after the introduction of NN.
iii) Although GP cannot fit the dataset well after several iterations, at the initial iterations, GP alone successfully lowers R from 25 to 18 n, and it suggests the exploration directions from medium Z to highest and lowest Z, which pushes us to expand the search space and identify the regions with low R.

One or more computers can be used to implement such a computational pipeline, using one or more general-purpose computers, such as client devices including mobile devices and client computers, one or more server computers, or one or more database computers, or combinations of any two or more of these, which can be programmed to implement the functionality such as described in the example implementations.

FIG. 9 is a block diagram of a general-purpose computer which processes computer programs using a processing system. Computer programs on a general-purpose computer generally include an operating system and applications. The operating system is a computer program running on the computer that manages access to resources of the computer by the applications and the operating system. The resources generally include memory, storage, communication interfaces, input devices and output devices.

Examples of such general-purpose computers include, but are not limited to, larger computer systems such as server computers, database computers, desktop computers, laptop and notebook computers, as well as mobile or handheld computing devices, such as a tablet computer, handheld computer, smart phone, media player, personal data assistant, audio and/or video recorder, or wearable computing device.

With reference to FIG. 9, an example computer 500 comprises a processing system including at least one processing unit 502 and a memory 504. The computer can have multiple processing units 502 and multiple devices implementing the memory 504. A processing unit 502 can include one or more processing cores (not shown) that operate independently of each other. Additional co-processing units, such as graphics processing unit 520, also can be present in the computer. The memory 504 may include volatile devices (such as dynamic random-access memory (DRAM) or other random-access memory device), and non-volatile devices (such as a read-only memory, flash memory, and the like) or some combination of the two, and optionally including any memory available in a processing device. Other memory such as dedicated memory or registers also can reside in a processing unit. Such a memory configures is delineated by the dashed line 504 in FIG. 9. The computer 500 may include additional storage (removable and/or non-removable) including, but not limited to, solid state devices, or magnetically recorded or optically recorded disks or tape. Such additional storage is illustrated in FIG. 9 by removable storage 508 and non-removable storage 510. The various components in FIG. 1 are generally interconnected by an interconnection mechanism, such as one or more buses 530.

A computer storage medium is any medium in which data can be stored in and retrieved from addressable physical storage locations by the computer. Computer storage media includes volatile and nonvolatile memory devices, and removable and non-removable storage devices. Memory 504, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 500 may also include communications connection(s) 512 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 512 are devices, such as a network interface or radio transmitter, that interface with the communication media to transmit data over and receive data from signals propagated through communication media.

The communications connections can include one or more radio transmitters for telephonic communications over cellular telephone networks, and/or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 500 may have various input device(s) 514 such as a various pointer (whether single pointer or multi-pointer) devices, such as a mouse, tablet and pen, touchpad and other touch-based input devices, stylus, image input devices, such as still and motion cameras, audio input devices, such as a microphone. The compute may have various output device(s) 516 such as a display, speakers, printers, and so on, also may be included. These devices are well known in the art and need not be discussed at length here.

The various storage 510, communication connections 512, output devices 516 and input devices 514 can be integrated within a housing of the computer, or can be connected through various input/output interface devices on the computer, in which case the reference numbers 510, 512, 514 and 516 can indicate either the interface for connection to a device or the device itself as the case may be.

An operating system of the computer typically includes computer programs, commonly called drivers, which manage access to the various storage 510, communication connections 512, output devices 516 and input devices 514. Such access generally includes managing inputs from and outputs to these devices. In the case of communication connections, the operating system also may include one or more computer programs for implementing communication protocols used to communicate information between computers and devices through the communication connections 512.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

Each component (which also may be called a “module” or “engine” or “computational model” or the like), of a computer system such as described herein, and which operates on one or more computers, can be implemented as computer program code processed by the processing system(s) of one or more computers. Computer program code includes computer-executable instructions and/or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

It should be understood that the subject matter defined in the appended claims is not necessarily limited to the specific implementations described above. The specific implementations described above are disclosed as examples only.

### INCORPORATION BY REFERENCE

All U.S. patents and U.S. and PCT patent application publications mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method for making lased poly(acrylonitrile) (PAN), comprising
obtaining a membrane comprising (PAN);
microstructuring the membrane;
thermally treating the membrane in air to produce a membrane comprising thermally stabilized PAN, wherein the thermal treating occurs at less than 300° C.; and
laser annealing the thermally stabilized membrane to produce lased PAN with a decreased sheet resistance, as compared to microstructured PAN, wherein the laser annealing is conducted by a computer comprising a Bayesian optimization program.

2. The method of claim 1, wherein the thermal treating occurs at about 200° C. to about 299° C.

3. (canceled)

4. The method of claim 1, wherein the thermal treatment increases the sp² content of the PAN as compared to PAN that has not been thermally treated.

5. (canceled)

6. The method of claim 1, wherein the thermally stabilized membrane comprises a high degree of carbonized and graphitized PAN, as compared to PAN that has not been thermally treated.

7. The method of claim 1, wherein the Bayesian Optimization program minimizes PAN electrical resistance by exploring one or more laser parameters selected from the group consisting of laser scan speed, laser power, focal point height (Z), and image density (I_{D}).

8. The method of claim 1, wherein the Bayesian Optimization program minimizes PAN electrical resistance by conditioning the thermally stabilized PAN using a laser having a Z-height, an image density, a power, and a speed.

9. The method of claim 8, wherein the Z-height is from 0.02 inches to 0.2 inches.

10-12. (canceled)

13. The method of claim 8, wherein the image density is 1 to 10.

14-17. (canceled)

18. The method of claim 8, wherein the power is 2 to 10 watts.

19. (canceled)

20. (canceled)

21. The method of claim 8, wherein the speed is 120 to 200 mm/s.

22. (canceled)

23. (canceled)

24. The method of claim 1, wherein the lased PAN is electrochemically active.

25. The method of claim 1, wherein the lased PAN has a resistance of about 5-20 Ω/sq.

26-28. (canceled)

29. The method of claim 1, wherein the lased PAN has an increased number of graphitic dendritic structures, as compared to un-lased PAN.

30. The method of claim 1, wherein the lased PAN has an increased number of edge sites, as compared to un-lased PAN.

31. The method of claim 1, wherein the lased PAN are configured to function as porous electrodes for a vanadium redox flow battery.

32. The method of claim 1, wherein microstructuring the membrane comprises subjecting the membrane to nonsolvent induced phase separation.

33. The method of claim 32, wherein subjecting the membrane to nonsolvent induced phase separation is performed under ambient conditions.

34. A lased PAN membrane, comprising a lased PAN produced by the method of claim 1.

35. An electrode, comprising the lased PAN membrane of claim 34.

36. A battery, comprising the lased PAN membrane of claim 34.

37. (canceled)

38. (canceled)
